(19) United States
(12) Patent Application Publication
(10) Pub. No.: US 2022/0083916 A1
(43) Pub. Date: Mar. 17, 2022

(54) SYSTEM AND METHOD FOR DETECTING AND RECTIFYING CONCEPT DRIFT IN FEDERATED LEARNING

(71) Applicant: Kabushiki Kaisha Toshiba, Tokyo (JP)

(72) Inventors: Aftab KHAN, Bristol (GB); Pietro E. CARNELLI, Bristol (GB); Timothy David FARNHAM, Bristol (GB); Ioannis MAVROMATIS, Bristol (GB); Anthony PORTELLI, Bristol (GB)

(73) Assignee: Kabushiki Kaisha Toshiba, Tokyo (JP)

(21) Appl. No.: 17/018,923

(22) Filed: Sep. 11, 2020

(51) Int. Cl. G06N 20/20

(52) U.S. Cl. CPC G06N 20/20

(57) ABSTRACT

A computer-implemented method for identifying and rectifying a machine learning drift in a federated learning deployment comprising a parameter server and a plurality of worker nodes, wherein a first worker node comprises: a first machine learning model trained using a first data source; and a second machine learning model trained using a second data source; wherein the first data source is generated by the first worker node and the second data source is generated by a second worker node; the method comprising calculating, by the first worker node, using a trusted data set, a first performance metric associated with the first machine learning model and a second performance metric associated with the second machine learning model and determining, by the first worker node, whether a potential drift has occurred in at least one of the first and the second machine learning models.

### FIELD

Embodiments described herein relate generally to a computer-implemented method for identifying and rectifying a machine learning drift in a federated learning deployment comprising a parameter server and a plurality of worker nodes.

### BACKGROUND

Federated Learning (FL) is a machine learning technique where a global machine learning model is generated by training multiple machine learning models on each of the edge devices using their local data samples.

Federated Learning allows multiple actors to build a robust, common, machine learning model without sharing their local data. Instead of sharing local data Federated Learning (FL) systems typically share the machine learning model parameters generated by the edge devices with a global server that aggregates (e.g. averages) the parameters to form a global model. Federated Learning (FL) represents a privacy aware, adaptive and communication efficient approach for large-scale Internet of Things (IoT) systems.

The ability to generate a global model without sharing local data is a particularly attractive aspect of Federated Learning (FL) models, especially where the local data is sensitive or private. However, this ability can also be exploited by bad actors.

Federated Learning (FL) models are created by aggregating model updates submitted by various actors. To protect confidentiality of the training data, the aggregator (that generates the global model) has no visibility of how these model updates were generated. As a result, Federated Learning (FL) is susceptible to model poisoning attacks where a malicious actor introduces backdoor functionality into the global model (which is then used to update all of the nodes), by first introducing back door functionality into a local model and then sending the model update parameters to the aggregator.

One use case for machine-learning algorithms is in the detection of cyber security threats and vulnerabilities. If a Federated Learning (FL) model is compromised in this use-case, the security of the whole ecosystem could be jeopardised. In light of this, a new approach to Federated Learning (FL) is required. In particular, a new approach to detecting infected local models and preventing the infected local models from affecting other nodes in an Internet-of-Things (IoT) network is required.

Arrangements of the embodiments will be understood and appreciated more fully from the following detailed description, made by way of example only and taken in conjunction with drawings in which:

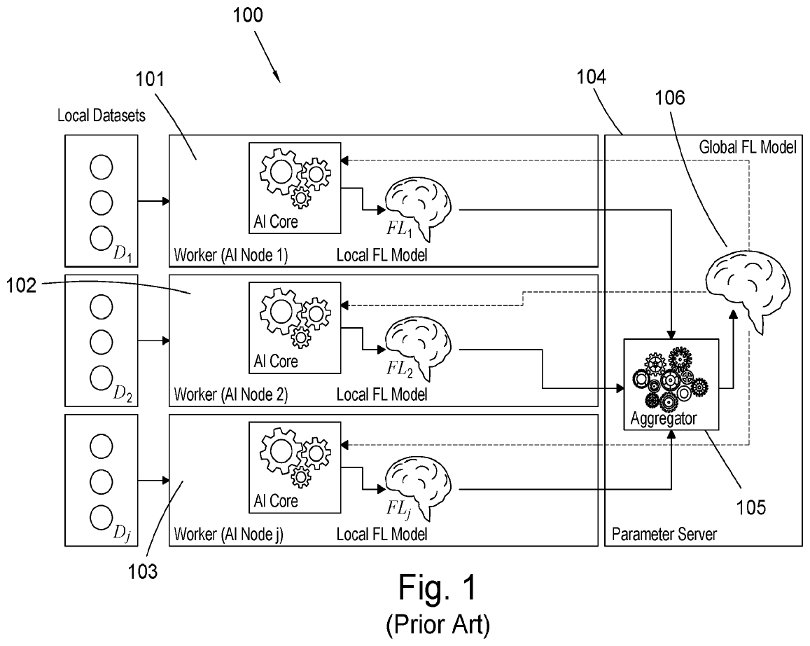

FIG. 1 shows a known Federated Learning (FL) deployment;

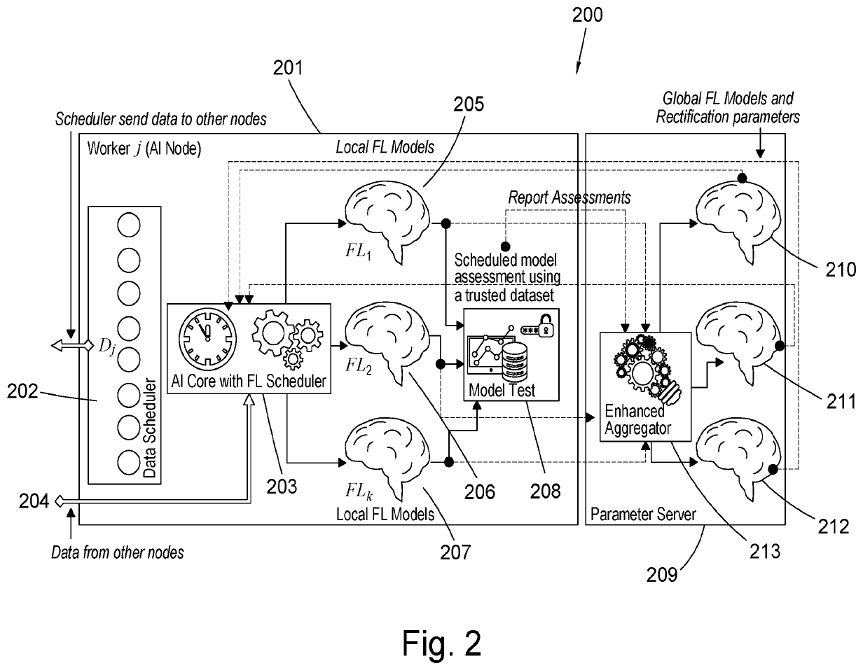

FIG. 2 shows a Federated Learning (FL) system comprising a worker node according to an embodiment;

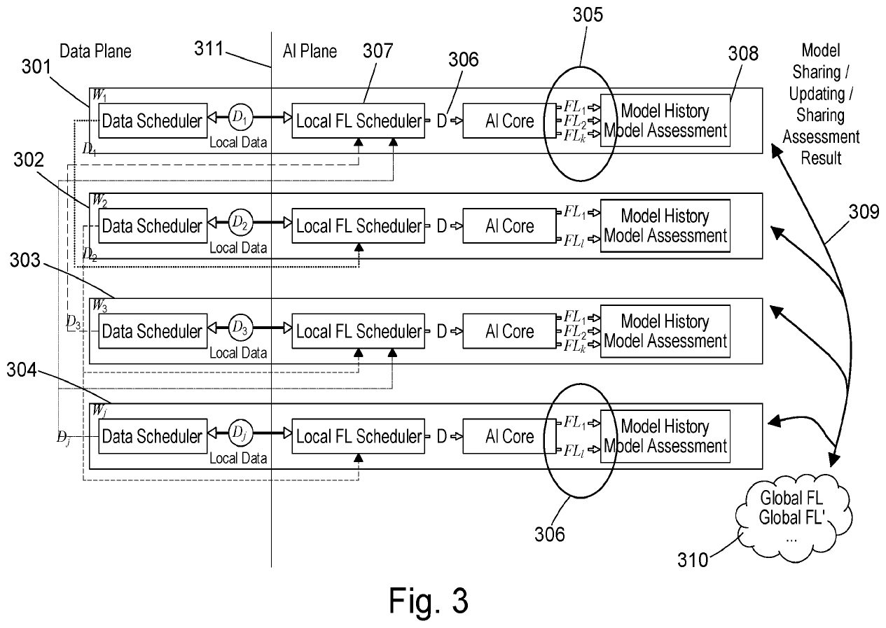

FIG. 3 shows a Federated Learning (FL) system comprising a plurality of worker nodes according to an embodiment;

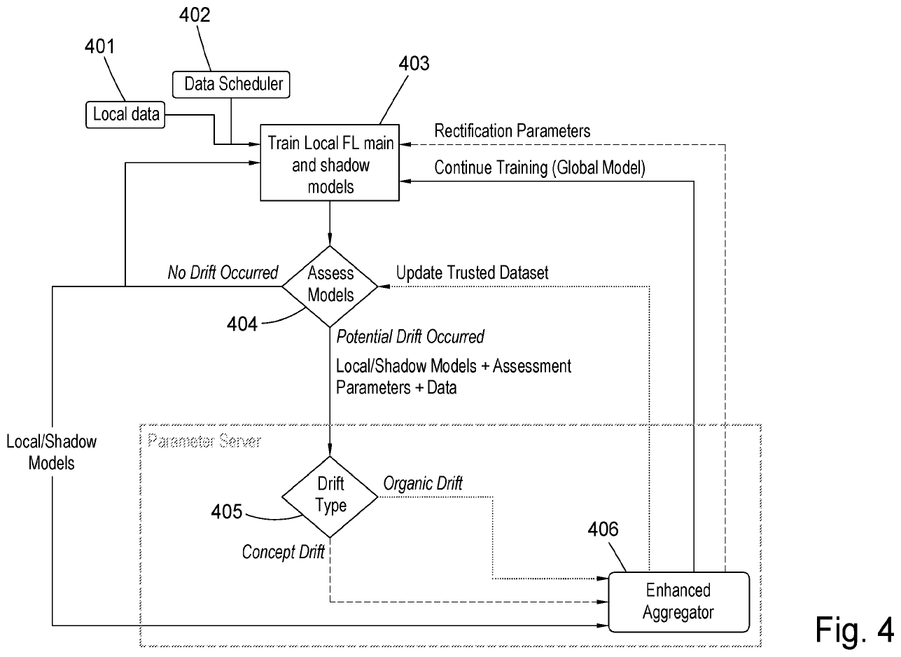

FIG. 4 shows a method for identifying and characterising drift in a Federated Learning (FL) system according to an embodiment;

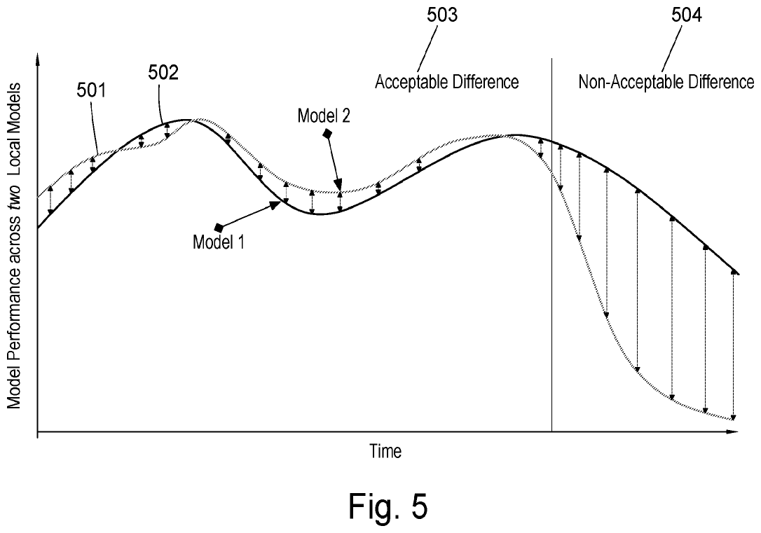

FIG. 5 shows a performance of two machine learning models at the same worker node according to an embodiment;

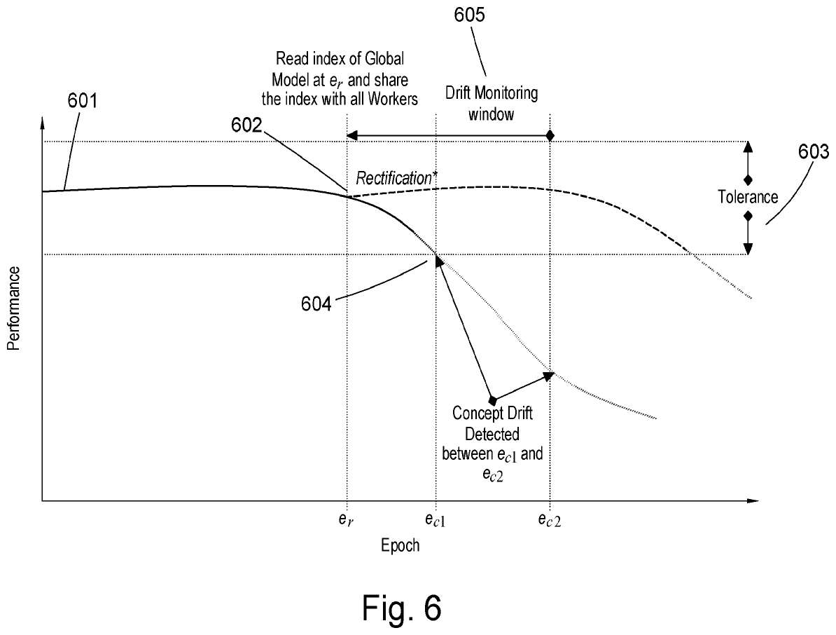

FIG. 6 shows an example of drift in model performance, rectification of a model and recovered performance according to an embodiment;

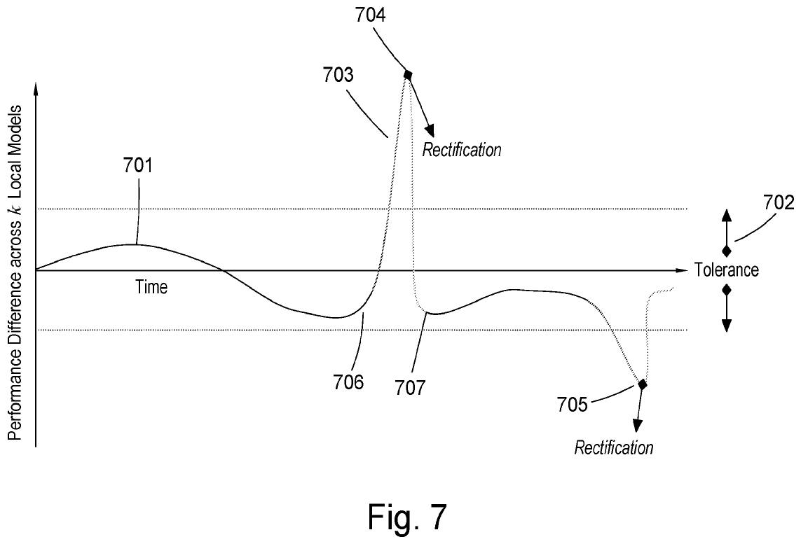

FIG. 7 shows a visual representation of model drift and rectification according to an embodiment;

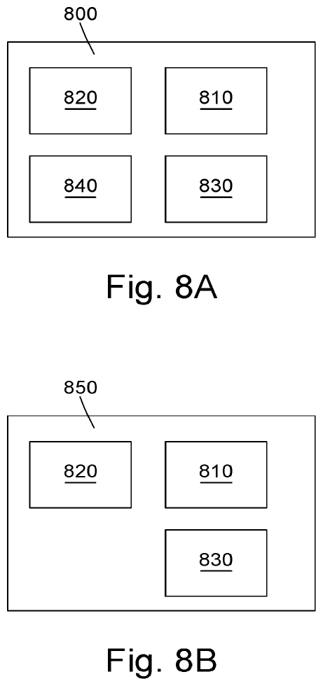

FIG. 8A shows an example of a worker node according to an embodiment;

FIG. 8B shows an example of a parameter server according to an embodiment.

### DETAILED DESCRIPTION

According to a first aspect there is provided a computer-implemented method for identifying and rectifying a machine learning drift in a federated learning deployment comprising a parameter server and a plurality of worker nodes. Wherein a first worker node comprises: a first machine learning model trained using a first data source; and a second machine learning model trained using a second data source; wherein the first data source is generated by the first worker node and the second data source is generated by a second worker node. The method comprising calculating, by the first worker node, using a trusted data set, a first performance metric associated with the first machine learning model and a second performance metric associated with the second machine learning model; determining, by the first worker node, whether a potential drift has occurred in at least one of the first and the second machine learning models. And in response to determining that the potential drift has occurred: transmitting, by the first worker node, a first communication comprising an indication that a potential drift has occurred; and in response to receiving the first communication, transmitting, by the parameter server, a second communication comprising updated parameters for rectifying the machine learning drift.

In an embodiment, the first machine learning model is a local model of the first worker node and the second machine learning model is a shadow model of the first worker node. In an embodiment, the parameter server is a communication apparatus and each worker node in the plurality of worker nodes is a communication apparatus.

In an embodiment, a machine learning drift is a reduction in performance of at least one machine learning model at a worker node.

In an embodiment, calculating a first performance metric associated with the first machine learning model comprises observing the accuracy of the first machine learning models output when the trusted data set is the input.

In an embodiment, determining whether the potential drift has occurred comprises: comparing the first performance metric and the second performance metric to a first performance threshold; and identifying the potential drift in response to determining that at least one of the first performance metric and the second performance metric has a performance metric that is less than the first performance threshold.

In an embodiment, a worse performance metric has a lower value.

In an embodiment determining whether the potential drift has occurred further comprises determining whether the difference between the first performance metric and the second performance metric exceeds the first threshold for a time period.

In an embodiment, the time period may be a drift monitoring window having a duration equal to a predetermined number of epochs.

In an embodiment, the first performance threshold is predetermined.

In an embodiment, the first performance threshold is an average of previous performance metrics associated with at least one of the first machine learning model and the second machine learning model.

In an embodiment, the second worker node comprises: a third machine learning model trained using the second data source; and a fourth machine learning model trained using the first data source.

In an embodiment, the first communication comprises the first performance metric and the second performance metric and the method further comprises identifying, by the parameter server, a type of drift and a set of affected machine learning model in response to receiving the first communication comprising the indication that the potential drift has occurred.

In an embodiment, the method further comprises receiving, by the parameter server, a third performance metric associated with the third machine learning model and a fourth performance metric associated with the fourth machine learning model. And wherein: identifying the type of drift comprises: setting organic drift as the type of drift in response to determining that the first performance metric, the second performance metric, the third performance metric and the fourth performance metric are each less than a second performance threshold; and wherein, in response to determining that the type of drift is organic drift identifying the set of affected machine learning models comprises: setting the first, second, third and fourth machine learning models as a first, second, third, and fourth affected machine learning model respectively in the set of affected machine learning models.

In an embodiment, organic drift is set as the type of drift in response to determining that: a performance of each machine learning model trained using the first data source is less than the second performance threshold and a performance of each machine learning model trained using the second data source is less than the second performance threshold.

In an embodiment, the updated parameters in the second communication transmitted by the parameter server comprise an updated trusted data set.

In an embodiment, the first communication further comprises data that was used to train the first machine learning model and the second machine learning model.

In an embodiment, the method further comprises generating the updated trusted data set by including at least part of the data that was used to train the first machine learning model and the second machine learning model in the trusted data set.

In an embodiment, the updated trusted data set is used by the worker nodes for all subsequent performance determinations.

In an embodiment, the second communication is transmitted to all worker nodes in the plurality of worker nodes.

In an embodiment, identifying the type of drift comprises setting a concept drift as the type of drift in response to determining that a difference between the first performance metric and the second performance metric exceeds a third threshold. And wherein, in response to determining that the type of drift is a concept drift, identifying the set of affected machine learning models comprises: setting the first machine learning model as a first affected machine learning model in the set of affected machine learning models in response to determining that the first performance metric is less than the second performance metric; and setting the second machine learning model as the first affected machine learning model in the set of affected machine learning models in response to determining that the second performance metric is less than the first performance metric.

In an embodiment the first machine learning model is set as the first affected machine learning model when the performance of the first machine learning model is worse than the performance of the second machine learning model.

In an embodiment, a worse performance and a worse performance metric is associated with a less accurate machine learning model.

In an embodiment, the type of drift is a concept drift and identifying the set of affected machine learning model further comprises: identifying a data source that is used to train the first affected machine learning model; identifying a worker node comprising a machine learning model trained using the data source; and setting the machine learning model trained using the data source as a second affected machine learning model in response to determining that a concept drift has occurred at the worker node and the machine learning model training using the data source has a lower performance metric than a performance metric of another machine learning model at the worker node.

In an embodiment, setting the fourth machine learning model as a second affected machine learning model in the set of machine learning models in response to determining that a concept drift has occurred at the second worker node and the performance of the fourth machine learning model is worse than the performance of the third machine learning model.

In an embodiment, the third machine learning model is a local machine learning model of the second worker node and the fourth machine learning model is a shadow machine learning model of the second worker node.

In an embodiment, the method further comprises receiving a further communication from the second worker node comprising an indication that a potential drift has occurred.

In an embodiment, the second communication comprising the updated parameters is transmitted to each worker node comprising an affected machine learning model in the set of affected machine learning models.

In an embodiment the method further comprises: transmitting, by the first worker node, model parameters of the first machine learning model and the second machine learning model; generating, by the parameter server, a first global machine learning model associated with the first machine learning model and a second global machine learning model associated with the second machine learning model; and transmitting, by the parameter server, a third communication comprising: model parameters of the first global machine learning model and model parameters of the second global machine learning model.

In an embodiment, the method further comprises storing, by the parameter server, the first global machine learning model and the second global machine learning model.

In an embodiment, the method further comprises receiving, by the first worker node, the third communication; and storing, by the first worker node, parameters of the first global machine learning model and the parameters of the second global machine learning model received in the third communication.

In an embodiment, the parameters of the first global machine learning model and the second global machine learning model are removed from the first worker node after a predetermined period of time has passed.

In an embodiment, generating the first global machine learning model comprises: identifying a first set of machine learning models for aggregation, the first set of machine learning models not including the set of affected machine learning models; and aggregating the first set of machine learning models.

In an embodiment, the first set of machine learning models for aggregation comprise machine learning models that are training using the data source generated the a worker node on which they are located.

In an embodiment, the first set of machine learning models for aggregation comprise the first machine learning model and the third machine learning model.

In an embodiment, aggregating the set of machine learning models comprises generating a single machine learning model that represents the set of machine learning models.

In an embodiment, aggregating the set of machine learning models comprises averaging the parameters of the machine learning models in the set of machine learning models.

In an embodiment, generating the second global machine learning model comprises identifying a second set of machine learning models for aggregation, the second set of machine learning models not including the set affected machine learning models; and aggregating the second set of machine learning models.

In an embodiment, the second set of machine learning models for aggregation comprise machine learning models that are training using a data source that is not generated by the worker node on which they are located.

In an embodiment, the updated parameters of the second communication comprise an indication that a machine learning model trained using the first data source has been affect by concept drift; and an indication of a time when the first global machine learning model was associated with acceptable performance.

In an embodiment, acceptable performance is a performance level that is higher than the first performance threshold.

In an embodiment, the indication of time is an index of an epoch.

In an embodiment, the method further comprises receiving, by the first worker node, the second communication; identifying, by the first worker node, model parameters of the first global machine learning model that are associated with the indication of the time in the second communication; and re-configuring, by the first worker node, the first machine learning model based on the model parameters of the first global machine learning model.

In an embodiment, model parameters define the model that is used to make predictions/inferences.

In an embodiment, a machine learning model generates and output based on the input and the model parameters.

In an embodiment, each worker node in the plurality of worker nodes comprises a database instance of a distributed database, the method further comprising: receiving, by the first worker node, a request to access a first database instance, the request comprising one or more access parameters; determining, by the first machine learning model, based on the one or more access parameters whether the transaction is authorised; and in response to determining that the transaction is authorised, servicing the request to access the first database instance, wherein: the one or more access parameters comprise at least one of: a nature of a requesting application, an identification of an end-user, and an indication of the data being requested.

In an embodiment, the trusted dataset comprises one or more applications and one or more end-users.

According to a second aspect there is provided a computer-implemented method for identifying and rectifying a machine learning drift at a first worker node, the first worker node comprising: a first machine learning model trained using a first data source; and a second machine learning model trained using a second data source; wherein the first data source is generated by the first worker node and the second data source is generated by a second worker node. The method comprising: calculating, using a trusted data set, a first performance metric associated with the first machine learning model and a second performance metric associated with the second machine learning model; determining, whether a potential drift has occurred in at least one of the first and the second machine learning models; and in response to determining that the potential drift has occurred: transmitting, a first communication comprising an indication that a potential drift has occurred; and receiving, a second communication comprising updated parameters for rectifying the machine learning drift.

In an embodiment, the updated parameters comprise an updated trusted data set.

In an embodiment, transmitting model parameters of the first machine learning model and the second machine learning model.

In an embodiment, determining whether the potential drift has occurred comprises: comparing the first performance metric and the second performance metric to a first performance threshold; and identifying the potential drift in response to determining that at least one of the first performance metric and the second performance metric has a performance metric that is less than the first performance threshold.

In an embodiment, the method further comprises receiving a third communication comprising: model parameters of the first global machine learning model; and model parameters of the second global machine learning model; and storing the model parameters of the first global machine learning model and the model parameters of the second global machine learning model.

In an embodiment, the model parameters of the first global machine learning model and the model parameters of the second global machine learning model are removed after a predetermined period of time has elapsed.

In an embodiment, the updated parameters of the second communication comprise: an indication that a machine learning model trained using the first data source has been affect by concept drift; and an indication of a time when the first global machine learning model was associated with acceptable performance.

In an embodiment, the method further comprises receiving the second communication, identifying model parameters of the first global machine learning model that are associated with the indication of the time in the second communication; and re-configuring the first machine learning model based on the model parameters of the first global machine learning model.

According to a third aspect there is provided a computer-implemented method for identifying and rectifying a machine learning drift in a federated learning deployment comprising a plurality of worker nodes, wherein a first worker node comprises: a first machine learning model trained using a first data source; and a second machine learning model trained using a second data source; wherein the first data source is generated by the first worker node and the second data source is generated by a second worker node. The method comprising receiving, from a first worker node, a first communication comprising an indication that a potential drift has occurred; and transmitting a second communication comprising updated parameters for rectifying the machine learning drift.

In an embodiment, the second worker node comprises: a third machine learning model trained using the second data source; and a fourth machine learning model trained using the first data source.

In an embodiment, the method further comprises: identifying a type of drift and a set of affected machine learning model in response to receiving the first communication comprising the indication that the potential drift has occurred.

In an embodiment, the first communication comprises a first performance metric associated with the first machine learning model and a second performance metric associated with the second machine learning model. The method further comprises: receiving a third performance metric associated with the third machine learning model and a fourth performance metric associated with the fourth machine learning model; and wherein: identifying the type of drift comprises: setting organic drift as the type of drift in response to determining that the first performance metric, the second performance metric, the third performance metric and the fourth performance metric are each less than a second performance threshold; and wherein in response to determining that the type of drift is organic drift, identifying the set of affected machine learning models comprises setting the first, second, third and fourth machine learning models as a first, second, third, and fourth affected machine learning model respectively in the set of affected machine learning models.

In an embodiment, the first communication comprises a first performance metric associated with a first machine learning model and a second performance metric associated with the second machine learning model; and identifying the type of drift comprises: setting a concept drift as the type of drift in response to determining that a difference between the first performance metric and the second performance metric exceeds a third threshold; and wherein, in response to determining that the type of drift is a concept drift, identifying the set of affected machine learning model comprises: setting the first machine learning model as a first affected machine learning model in the set of affected machine learning models in response to determining that the first performance metric is less than the second performance metric; and setting the second machine learning model as the first affected machine learning model in the set of affected machine learning models in response to determining that the second performance metric is less than the first performance metric.

In an embodiment the type of drift is a concept drift and identifying the set of affected machine learning model further comprises identifying a data source that is used to train the first affected machine learning model; identifying a worker node comprising a machine learning model trained using the data source; and setting the machine learning model trained using the data source as a second affected machine learning model in response to determining that a concept drift has occurred at the worker node and the machine learning model training using the data source has a lower performance metric than a performance metric of another machine learning model at the worker node.

In an embodiment, the second communication comprising the updated parameters is transmitted to each worker node comprising an affected machine learning model in the set of affected machine learning models.

In an embodiment, the method further comprises: receiving model parameters of the first machine learning model and the second machine learning model; generating a first global machine learning model associated with the first machine learning model and a second global machine learning model associated with the second machine learning model; and transmitting a third communication comprising: model parameters of the first global machine learning model and model parameters of the second global machine learning model.

In an embodiment, generating the first global machine learning model comprises: identifying a first set of machine learning models for aggregation, the first set of machine learning models not including the set of affected machine learning models; and aggregating the first set of machine learning models.

In an embodiment the updated parameters of the second communication comprise: an indication that a machine learning model trained using the first data source has been affect by concept drift; and an indication of a time when the first global machine learning model was associated with acceptable performance.

According to a fourth aspect there is provided a federated learning deployment system comprising a parameter server and a plurality of worker nodes, wherein a first worker node comprises: a first machine learning model trained using a first data source; and a second machine learning model trained using a second data source; wherein the first data source is generated by the first worker node and the second data source is generated by a second worker node. The first worker node being configured to: calculate, using a trusted data set, a first performance metric associated with the first machine learning model and a second performance metric associated with the second machine learning model; determine, whether a potential drift has occurred in at least one of the first and the second machine learning models; and in response to determining that the potential drift has occurred: transmit a first communication comprising an indication that a potential drift has occurred. Wherein the parameter server is configured to transmit, in response to receiving the first communication, a second communication comprising updated parameters for rectifying the machine learning drift.

In an embodiment, wherein in determining whether the potential drift has occurred the first worker node is configured to: compare the first performance metric and the second performance metric to a first performance threshold; and identify the potential drift in response to determining that at least one of the first performance metric and the second performance metric has a performance metric that is less than the first performance threshold.

In an embodiment, the second worker node comprises: a third machine learning model trained using the second data source; and a fourth machine learning model trained using the first data source.

In an embodiment, the first communication comprises the first performance metric and the second performance metric and the parameter server is further configured to: identify a type of drift and a set of affected machine learning model in response to receiving the first communication comprising the indication that the potential drift has occurred.

In an embodiment, the parameter server is further configured to receive a third performance metric associated with the third machine learning model and a fourth performance metric associated with the fourth machine learning model; and wherein, when identifying the type of drift, the parameter server is further configured to: set organic drift as the type of drift in response to determining that the first performance metric, the second performance metric, the third performance metric and the fourth performance metric are each less than a second performance threshold; and wherein, in response to determining that the type of drift is organic drift the parameter server is configured to identify the set of affected machine learning models by: setting the first, second, third and fourth machine learning models as a first, second, third, and fourth affected machine learning model respectively in the set of affected machine learning models.

In an embodiment, the updated parameters in the second communication transmitted by the parameter server comprise an updated trusted data set.

In an embodiment, when identifying the type of drift, the parameter server is configured to: set a concept drift as the type of drift in response to determining that a difference between the first performance metric and the second performance metric exceeds a third threshold; and wherein, in response to determining that the type of drift is a concept drift, the parameter server is configured to identify the set of affected machine learning models by: setting the first machine learning model as a first affected machine learning model in the set of affected machine learning models in response to determining that the first performance metric is less than the second performance metric; and setting the second machine learning model as the first affected machine learning model in the set of affected machine learning models in response to determining that the second performance metric is less than the first performance metric.

In an embodiment, the type of drift is a concept drift and wherein when identifying the set of affected machine learning models the parameter server is further configured to: identify a data source that is used to train the first affected machine learning model; identify a worker node comprising a machine learning model trained using the data source; and set the machine learning model trained using the data source as a second affected machine learning model in response to determining that a concept drift has occurred at the worker node and the machine learning model training using the data source has a lower performance metric than a performance metric of another machine learning model at the worker node.

In an embodiment, the second communication comprising the updated parameters is transmitted to each worker node comprising an affected machine learning model in the set of affected machine learning models.

In an embodiment, the first worker node is further configured to transmit model parameters of the first machine learning model and the second machine learning model and wherein the parameter server is further configured to generate a first global machine learning model associated with the first machine learning model and a second global machine learning model associated with the second machine learning model; and transmit a third communication comprising: model parameters of the first global machine learning model and model parameters of the second global machine learning model.

In an embodiment, when generating the first global machine learning model, the parameter server is further configured to identify a first set of machine learning models for aggregation, the first set of machine learning models not including the set of affected machine learning models; and aggregate the first set of machine learning models.

In an embodiment, the updated parameters of the second communication comprise: an indication that a machine learning model trained using the first data source has been affect by concept drift; and an indication of a time when the first global machine learning model was associated with acceptable performance.

In an embodiment, the first worker node is further configured to receive the second communication; identify model parameters of the first global machine learning model that are associated with the indication of the time in the second communication; and re-configure the first machine learning model based on the model parameters of the first global machine learning model.

According to a fifth aspect there is provided: a first machine learning model trained using a first data source; and a second machine learning model trained using a second data source; wherein the first data source is generated by the first worker node and the second data source is generated by a second worker node. The apparatus configured to: calculate, using a trusted data set, a first performance metric associated with the first machine learning model and a second performance metric associated with the second machine learning model; determine, whether a potential drift has occurred in at least one of the first and the second machine learning models; and in response to determining that the potential drift has occurred: transmit, a first communication comprising an indication that a potential drift has occurred; and receive, a second communication comprising updated parameters for rectifying the machine learning drift.

In an embodiment, the apparatus is a worker node.

In an embodiment, when determining whether the potential drift has occurred the apparatus is configured to: compare the first performance metric and the second performance metric to a first performance threshold; and identify the potential drift in response to determining that at least one of the first performance metric and the second performance metric has a performance metric that is less than the first performance threshold.

In an embodiment, the apparatus is further configured to receive a third communication comprising: model parameters of the first global machine learning model; and model parameters of the second global machine learning model; and store the model parameters of the first global machine learning model and the model parameters of the second global machine learning model.

In an embodiment the apparatus is configured to remove the model parameters of the first global machine learning model and the model parameters of the second global machine learning model after a predetermined period of time has elapsed.

In an embodiment, the updated parameters of the second communication comprise: an indication that a machine learning model trained using the first data source has been affect by concept drift; and an indication of a time when the first global machine learning model was associated with acceptable performance.

In an embodiment, the apparatus is further configured to receive the second communication; identify model parameters of the first global machine learning model that are associated with the indication of the time in the second communication; and re-configuring the first machine learning model based on the model parameters of the first global machine learning model.

According to a sixth aspect there is provided an apparatus for identifying and rectifying a machine learning drift in a federated learning deployment comprising a plurality of worker nodes, wherein a first worker node comprises: a first machine learning model trained using a first data source; and a second machine learning model trained using a second data source; wherein the first data source is generated by the first worker node and the second data source is generated by a second worker node. The apparatus being configured to: receive, from a first worker node, a first communication comprising an indication that a potential drift has occurred; and transmit a second communication comprising updated parameters for rectifying the machine learning drift.

In an embodiment, the apparatus is a parameter server.

In an embodiment, the second worker node comprises: a third machine learning model trained using the second data source; and a fourth machine learning model trained using the first data source.

In an embodiment, the apparatus is further configured to: identify a type of drift and a set of affected machine learning model in response to receiving the first communication comprising the indication that the potential drift has occurred.

In an embodiment, the first communication comprises a first performance metric associated with the first machine learning model and a second performance metric associated with the second machine learning model, and wherein the apparatus is further configured to: receive a third performance metric associated with the third machine learning model and a fourth performance metric associated with the fourth machine learning model; and wherein, when identifying the type of drift, the apparatus is further configured to: set organic drift as the type of drift in response to determining that the first performance metric, the second performance metric, the third performance metric and the fourth performance metric are each less than a second performance threshold; and wherein in response to determining that the type of drift is organic drift, when identifying the set of affected machine learning models, the apparatus is configured to set the first, second, third and fourth machine learning models as a first, second, third, and fourth affected machine learning model respectively in the set of affected machine learning models.

In an embodiment, the first communication comprises a first performance metric associated with a first machine learning model and a second performance metric associated with the second machine learning model; and wherein, when identifying the type of drift, the apparatus is configured to: set a concept drift as the type of drift in response to determining that a difference between the first performance metric and the second performance metric exceeds a third threshold; and wherein, in response to determining that the type of drift is a concept drift, identifying the set of affected machine learning model comprises: setting the first machine learning model as a first affected machine learning model in the set of affected machine learning models in response to determining that the first performance metric is less than the second performance metric; and setting the second machine learning model as the first affected machine learning model in the set of affected machine learning models in response to determining that the second performance metric is less than the first performance metric.

In an embodiment, the type of drift is a concept drift and when identifying the set of affected machine learning models the apparatus is further configured to: identify a data source that is used to train the first affected machine learning model; identify a worker node comprising a machine learning model trained using the data source; and set the machine learning model trained using the data source as a second affected machine learning model in response to determining that a concept drift has occurred at the worker node and the machine learning model training using the data source has a lower performance metric than a performance metric of another machine learning model at the worker node.

In an embodiment, the second communication comprising the updated parameters is transmitted to each worker node comprising an affected machine learning model in the set of affected machine learning models.

In an embodiment, the apparatus is further configured to: receive model parameters of the first machine learning model and the second machine learning model; generate a first global machine learning model associated with the first machine learning model and a second global machine learning model associated with the second machine learning model; and transmit a third communication comprising: model parameters of the first global machine learning model and model parameters of the second global machine learning model.

In an embodiment, when generating the first global machine learning model, the apparatus is further configured to: identify a first set of machine learning models for aggregation, the first set of machine learning models not including the set of affected machine learning models; and aggregate the first set of machine learning models.

In an embodiment, the updated parameters of the second communication comprise: an indication that a machine learning model trained using the first data source has been affect by concept drift; and an indication of a time when the first global machine learning model was associated with acceptable performance.

According to a seventh aspect there is provided a non-transitory computer readable medium storing computer readable instructions which, when executed by a processor, cause the processor to: calculate, using a trusted data set, a first performance metric associated with the first machine learning model and a second performance metric associated with the second machine learning model; determine, whether a potential drift has occurred in at least one of the first and the second machine learning models; and in response to determining that the potential drift has occurred: transmit, a first communication comprising an indication that a potential drift has occurred; and receive, a second communication comprising updated parameters for rectifying the machine learning drift.

According to an eighth aspect there is provided a non-transitory computer readable medium storing computer readable instructions which, when executed by a processor, cause the processor to: receive, from a first worker node, a first communication comprising an indication that a potential drift has occurred; and transmit a second communication comprising updated parameters for rectifying the machine learning drift.

In general, a worker node (also referred to as an edge node) is any electronic device that can form an endpoint of a network connection, or in other words a device that is located at the edge of a network. For example, a worker node could be an Internet-of-Things (IoT) device that is configured to collect and exchange data on a network. Throughout the description the term “machine learning model” is used to represent a system which receives input data of a particular form and provides an output (e.g. a result) based on the data. The output may be predictive and/or indicative of a state of the worker node or the surrounding environment. Optionally, the input data to the machine learning model comprises a measurement of one or more of: a physical parameter, an operating parameter and/or a device parameter.

FIG. 1 shows a known Federated Learning (FL) deployment. FIG. 1 shows a Federated Learning (FL) deployment 100 comprising a first worker node 101, a second worker node 102, a third worker node 103 and a parameter server 104.

Each worker node (101; 102; 103) comprises a machine learning model (FL₁, FL₂, FL₁ respectively) that is trained using local data (i.e. data received from sources local to the worker node e.g. device inputs or sensor data). In FIG. 1 the machine learning model of the first worker node 101, FL₁, uses a first data set D₁ for training; the machine learning model of the second worker node 102, FL₂, uses a second data set, D₂, for training; and the machine learning model of the third worker node 103, FLⱼ, uses the data set Dⱼ for training.

Optionally the local datasets used for training (D₁, D₂, Dⱼ) are subsets of a larger dataset distributed by a central server (e.g. the parameter server 104).

In a different embodiment the local datasets used for training (D₁, D₂, Dⱼ) contain data that is locally collected by each node (i.e. the respective training datasets are not part of a larger global data set). In this embodiment, the locally generated data remains local to the node at all times and is never shared with the parameter server 104, thereby preserving the user's privacy.

After local models have been trained, the resulting local models are communicated by each worker node to the parameter server 104 where the machine learning models are aggregated (e.g. parameters are summed and averaged) by an aggregator 105 in order to produce a global model 106.

Machine learning models are routinely trained and evaluated using different parts of a single data set. Whilst being quick and simple to implement, this approach suffers a performance decay over time once the machine learning model is deployed and used with a previously unseen data set. In order to maintain performance levels there is a need to continuously train the model using new data. This need is particularly apparent where the model is deployed in a real-world non-stationary environment where the data and the relationships within the data change over time. When the data and the relationships within the data change, a decay in the performance of the machine learning mode can be observed. This is known as drift.

One type of drift is “organic drift”. Organic drift (also referred to as “natural drift”) relates to a situation where the data set evolves, potentially introducing a previously unseen variety or distribution of data. Organic drift manifests itself as a drop in model accuracy at more than one node in the Federated Learning (FL) deployment. Optionally, the reduction in model accuracy can be observed in a majority of the worker nodes.

Another type of drift is “concept drift”. Unlike organic drift, concept drift may be caused by an attack on a particular node or a small subset of the nodes in the Federated Learning (FL) deployment. A number of different sources of concept drift that will be considered herein.

A first source of concept drift is when the local data is poisoned (i.e. when a bad actor maliciously changes part of the local data). Concept drift is then caused by the models being trained using this poisoned/compromised data. In this case, a reduction in model accuracy will only be detectable at the poisoned nodes (or in other words, those nodes in the deployment that use the poisoned data source). This is different to organic drift, which can be detected on a large number of nodes.

A second source of concept drift is when the parameters of a local model are attacked (e.g. by a bad actor changing the machine learning model parameters). This attack leads to a poisoned local model. In this case, a drift will only be identified at the worker node hosting the poisoned local model. There are at least two other potential sources of concept drift that will be discussed herein. However, these will be introduced in detail below when describing the structure of the Federated Learning (FL) deployment.

The distributed nature of Federated Learning (FL) systems means that they are especially vulnerable to attacks. For example, a machine learning model used for cyber security applications could be trained such that a piece of code that was once considered to be a “threat” (e.g. malware) is no longer considered a threat. In a Federated Learning (FL) environment, the machine learning model of the attacked node would then be shared with an aggregator and subsequently used to update the global model which is shared amongst all of the other nodes in the system. As will be appreciated, this represents a serious threat in Federated Learning (FL) systems, in particular security critical Internet of Things (IoT) systems, as it allows cyber security threats to evolve and compromise the security of the whole IoT ecosystem.

Statistical methods have previously been used in a centralised machine learning framework to detect concept drift. These methods generally involve comparing training samples with samples obtained during deployment. However, this approach is not applicable in Federated Learning (FL) systems since the worker nodes do not share their data with a centralised server.

A previous approach to preventing drift has involved frequently updating the machine-learning model. However, when models are updated in this way there is a lag between the new data arriving and the decision-making. Moreover, in practice this approach should only be used when the models are sufficiently trained or if there is a significant change in the model (e.g. organic drift has occurred, data is significantly different, new training results in significant model changes etc.). However, in Federated Learning deployments there is no set training or deployment time. Instead, training of the machine learning model happens continuously as new data arrives. Consequently, this approach is not appropriate for Federated Learning (FL) deployments.

Furthermore, in a Federated Learning (FL) system the machine learning model of a worker nodes is shared with a server, which then generates (through aggregation) a global model that is shared amongst the worker nodes. Consequently, even if concept drift is detected in a Federated Learning (FL) system, it extremely difficult to identify which node caused this drift. In light of this, a new approach to detecting and rectifying drift in Federated Learning (FL) systems is required.

FIG. 2 shows a Federated Learning system comprising a worker node according to an embodiment. FIG. 2 shows a Federated Learning (FL) system 200 comprising a first worker node 201 and a parameter server 209.

The worker node 201 comprises a data scheduler 202. The data scheduler 202 is configured to communicate the local data that it uses for training a local machine learning model to other worker nodes. In this example, local data includes data generated by the worker node and data received by the worker node from an associated data-generating input device, such as one or more sensors.

This approach is different to traditional Federated Learning (FL) systems where each worker node only has access to its own local data (i.e. there is no communication of local data).

In an embodiment, the system comprises a plurality of worker nodes and the local data is communicated to at least one other worker node. Optionally the at least one other worker node is selected at random or by using a time scheduled approach.

The worker node 201 further comprises a local Federated Learning (FL) scheduler 203. The local Federated Learning (FL) scheduler 203 is configured to schedule training tasks (i.e. training of the worker node's machine learning models). The local Federated Learning (FL) scheduler 203 is configured to receive data from other worker nodes.

In an embodiment, the local Federated Learning (FL) scheduler 203 implements cyclic training. During cyclic training the local Federated Learning (FL) scheduler 203 schedules training for each of its machine learning models (i.e. a local model and any shadow models) for a predetermined number of epochs, one after the other, in a cyclic (i.e. repeating) schedule. An epoch in this context refers to the time period required to train the model using the training data set (i.e. the time required to cycle through the full training set).

Each worker node also comprises a plurality of local Federated Learning (FL) models. In FIG. 2 the worker node 201 comprises three local Federated Learning (FL) models including: a first machine learning model (FL₁) 205, a second machine learning model (FL₂) 206 and a third machine learning model (FLₖ) 207.

Of these models, at least one model is a local model and at least one model is a shadow model. A local model is a machine learning model that is trained solely on local data (i.e. data generated at or near the worker node). In contrast a shadow model is a machine learning model that is trained using data generated by and received from other worker nodes. In FIG. 2 the shadow models are trained using data received from other nodes 204 via the Federated Learning (FL) scheduler 203.

Each worker node further comprises a model performance assessment engine 208. The model performance assessment engine 208 is configured to assess the performance of all local Federated Learning (FL) models (i.e. FL₁, FL₂ and FLₖ) using a trusted data set. The effects of this analysis will be discussed in further detail below. However in brief, the model performance assessment engine 208 is configured to identify whether or not at least one model of the plurality of machine learning models present at the worker node could potentially be the subject of a drift (e.g. organic drift or concept drift). Upon identifying a potential drift the worker nodes are configured to indicate this to the parameter server 209 which then: determines the type of drift at the worker node, identifies the infected worker nodes, and devises a strategy to rectify the drift.

The parameter server 209 comprises an enhanced aggregator 213. The function of the enhanced aggregator 213 will be discussed in more detail below. However, in general the enhanced aggregator 213 is configured to generate a global machine learning model based on the model parameters received from each of the worker nodes. The parameter server 209 comprises a plurality of global machine learning models (210; 211; 212). Each global machine learning model is associated with (e.g. is generated based on) machine learning models from a plurality of different worker nodes, and each of the global machine learning models are associated with different machine learning model at a given worker node.

For example, where each worker node comprises three machine learning models (i.e. a local model and two shadow models), the parameter server comprises three global machine learning models. In this case: a first global machine learning model is generated by aggregating model parameters from the local model of each worker node; a second global machine learning model is generated by aggregating model parameters from the first shadow model at each worker node; and the third global machine learning model is generated by aggregating model parameters from the second shadow model at each worker node.

After generating the global machine learning models the parameter server 209 is configured to communicate parameters of the global machine learning models to each worker node.

Each worker node 201 further comprises a model history storage (not shown). The model history storage is configured to store the model parameters of each global machine learning model generated by the parameter server.

Model updates can be stored in various ways including model state differences and using immutable ledger technology including on a blockchain. In an embodiment, the model history comprises the changes (i.e. differences) with respect to the previous model rather than a complete description of the machine learning model. In an embodiment the history of the machine learning model is only stored for a pre-determined time frame (e.g. for double the size of a monitoring window).

FIG. 3 shows a Federated Learning (FL) system comprising a plurality of worker nodes according to an embodiment. FIG. 3 shows a system comprising a plurality of J worker nodes, where J is the number of worker nodes. The plurality of worker nodes comprises a first worker node 301 (W₁), a second worker node 302 (W₂), a third worker node 303 (W₃) up to a worker node 304. In FIG. 3 J=4 (i.e. J equals four), therefore the j^{th} worker node 304 can also be referred to as a fourth worker node.

Each worker node in the plurality of worker nodes comprises a plurality of AI models (also known as machine learning models). This is in contrast to traditional approaches to Federated Learning (FL) where each worker node only comprises a single AI model.

In an embodiment, the number of AI models in various worker nodes are different. For example, in the embodiment of FIG. 3 the number of AI models per node equals K or L where (K, L)≤J (where J equals the number of worker nodes). In FIG. 3 the first worker node 301 (W₁) comprises three AI models 305 (FL₁, FL₂, FLₖ). In contrast, the j^{th} worker node 304 comprises two AI models 306 (FL₁ and FLⱼ).

The number of machine learning modes per node (i.e. (K, L)≤J) represents a trade-off. For example, a greater number of shadow models ensures a more secure Federated Learning system (i.e. a Federated Learning system that is less likely to suffer from drift). However, a greater number of shadow models results in an increased communications overhead and computational workload since each shadow model uses data communicated from a different worker node.

The system of FIG. 3 also comprises J data sources (e.g. D₁, D₂, D₃, Dⱼ). In FIG. 3 the number of data sources equals the number of worker nodes and each worker node comprises a number of AI models that is less than, or equal to the number of data sources.

Each worker node (301; 302; 303; 304) also comprises a data stream 306. The data stream 306 comprises local data (e.g. D₁) and data received via a local Federated Learning (FL) scheduler 307.

For example, in the first worker node 301 the local Federated Learning (FL) scheduler 307 receives data from the third worker node 303 and the j^{th} worker node 304. In FIG. 3 the data generated by the third worker node 303 and the j^{th} worker node 304 are transmitted by a data scheduler in each of the respective worker nodes to the local Federated Learning (FL) scheduler 307 in the first worker node 601.

Each worker node further comprises a model history and model assessment component 308. In use, each worker node assess each of its AI models using a trusted data set. The results of these assessments are stored at the worker node in order to identify performance deterioration of the AI model over time.

The model history and model assessment component 308 also stores parameters of the global machine learning models generated by the parameter server. As discussed above, each machine learning model at the worker node is associated with a different global machine learning model. As will be discussed in more detail below, the model history is used by worker node to go back in time and select a last stable model once it has been identified that a drift has occurred.

Updated model parameters for each machine learning model (e.g. FL₁, FL₂, FLₖ) are communicated 309 by the worker node (e.g. 301) to the parameter server as the AI models in the worker node are trained and updated.

FIG. 3 further shows a plurality of global Federated Learning (FL) models 310, each global machine learning model is associated with a machine learning model at each worker node, and each global model is generated by aggregating the parameters of the associated machine learning models. Each global machine learning model is associated with a machine learning model at each node such that no two models at a worker node are associated with the same global model.

Optionally, a global machine learning model is associated with machine learning models at the worker nodes that have similar properties. For example, a first global machine learning model is associated with (i.e. is generated by aggregating model parameters from) a local machine learning model at the first worker node 301 (FL₁), a local machine learning model at a second worker node 302 (FL₁), a local machine learning model at a third worker node 303 (FL₁) etc. While a second global machine learning model is associated with (i.e. is generated by aggregating model parameters from) a first shadow model at the first worker node 301 (FL₂), a first shadow model at the second worker node 302 (FL₁), a first machine learning model at a third worker node 303 (FL₂) etc.

FIG. 4 shows a method for identifying and characterising drift in a Federated Learning (FL) system according to an embodiment. The method will be described in relation to the system of FIG. 3. However, for the avoidance of doubt it is emphasised that other Federated Learning (FL) systems could also be used to implement the method.

In step 401 the local Federated Learning (FL) scheduler 307 receives local data 401 from a local data source (e.g. D₁, D₂, D₃, Dⱼ) associated with the worker node (e.g. 301; 302; 303; 304).

In step 402 the local Federated Learning (FL) scheduler 307 receives data from other worker nodes. In the embodiment of FIG. 3, the local Federated Learning scheduler 307 receives data from the third worker node 303 and the fourth worker node 304.

In step 403 the worker node 301 trains a plurality of machine learning models 305 based on the data stream 306 (comprising local data (D₁) and data from other worker nodes). In step 403 a first machine learning model of the plurality of machine learning models (i.e. “the local model”) is trained using only local data (D₁) while the remaining models (i.e. “the shadow models”) in the plurality of machine learning models are trained using data received from other worker nodes via the data scheduler 402. Each machine learning model is trained using only a single data source.

In step 404 the performance of the plurality of machine learning models are assessed by the worker node 301 in order to detect a possible drift (e.g. concept drift or organic drift). Optionally, the machine learning models are assessed periodically (e.g. after a predetermined time has passed or after the model has been re-trained a predetermined number of times).

The worker node 301 can use various approaches for assessing the performance of the machine learning model, including detecting a drift based on a change in machine learning model confidence scores or by using an anomaly detection algorithm. In a third approach, which will be used below, the worker node 301 determines the performance of each machine learning model by testing the accuracy of the machine learning model using a trusted dataset.

In this case, a possible drift is detected when at least one of the machine learning models at the worker node suffers a performance decay for a predetermined time period. In an embodiment, the performance is measured by the accuracy with which the machine learning model predicts an output for the trusted data set and a performance decay is observed when the performance is less than a predetermined threshold, or a predetermined amount less than an average performance.

The predetermined time corresponds to a drift monitoring window. A drift monitoring window is used by the worker node to distinguish between performance decays that are due to training noise (i.e. natural variations in the data that the model is trained on) and performance decays that are caused by drift. In the method of FIG. 4, the worker node 301 identifies a potential drift has occurred if a performance decay is observed at the worker node 301 throughout the drift monitoring window. Or in other words, a potential drift is identified when the performance of at least one machine learning model at the worker node 301 is less than a threshold for the duration a drift monitoring window.

If, in step 404, it is determined that no drift has occurred the parameters of the machine learning models at the worker node 301 are communicated to the parameter server. After it has been determined that no drift has occurred at the worker node, the worker node returns to step 403 and continues training the plurality of machine learning models 305.

If it is determined in step 404 that no drift has been identified in the machine learning models at a worker node the parameter server generates new global machine learning models using the received local/shadow model parameters. The parameter server subsequently distributes the updated global model to the worker nodes where it is stored in the model history storage component.

If, in step 404, it is determined that a potential drift has occurred at the worker node 301, the worker node 301 transmits an indication that a potential drift has occurred to the parameter server. The indication that a potential drift has occurred comprises: an indication of the affected worker node (e.g. a unique reference number), model parameters of the machine learning models at the worker node 301 (e.g. the local model and the at least one shadow model), data with which the machine learning models were trained, and assessment parameters of the machine learning models present at the worker node 301.

In an embodiment, the assessment parameters comprise an indication of the time when the affected machine learning model was last stable (i.e. the most-recent point in time when the performance of the machine leaning model was acceptable) and/or an indication of the time when performance decay was first observed for the affected machine learning model.

After receiving an indication that a potential drift has occurred, the parameter server determines the type of drift in step 405 (i.e. whether an organic drift or a concept drift has occurred).

Considering organic drift first. An organic drift is detected by the parameter server when the performance of more than one machine learning model at the worker node 301 decays or deteriorates at the same time. Optionally, the reduction in performance will be seen for all machine learning models at the worker node.

The number of machine learning models that are subject to organic drift depends on the properties of Federated Learning (FL) deployment. As discussed above, an organic drift can occur when the data set evolves and introduces a previously unseen variety or distribution of data. Consequently, the worker nodes and the machine learning models that are affected by an organic drift will depend on the attributes of the data sources that are used to train the machine learning models at each worker node.

For example, in a Federated Learning (FL) deployment, a first set of nodes could be located in a first geographic area and a second set of nodes could be located in a second geographic area. The ability of a machine learning model to make accurate predictions is dependent on the training data being representative. If, for example, the first geographic area is an extremely hot climate, then machine learning models that are training using data sources from the first geographic area only have a limited knowledge of temperatures. In light of this, it is foreseeable that when models trained using data generated in the first geographic area are tested against a trusted data set, they will perform worse than machine learning models trained using data sources from the second geographic area (that produce temperature data with a similar distribution to the trusted data set). In this case a performance decay would be observed for a subset of the machine learning models at a worker node, specifically the subset of machine learning models that were trained using data generated in the first geographic area.

In this example, an organic drift is observed in machine learning models that are trained using data sources that have a common attribute, that attribute being geographic area that the data source is located in. For the avoidance of doubt, it is noted that geographic area is not the only possible attribute. Other attributes of the data source could include the manufacturer/model of a sensor generating the data and the type/version of the worker node. In general, an attribute includes a property of the data source that affects the values of the data being generated.

The parameter server stores a configuration of the Federated Learning (FL) deployment. The configuration comprises information identifying the data source that is used to train each machine learning model at each worker node. Consequently, after it has been determined that at least a subset of the machine learning models at a first worker node have suffered a performance decay, the parameter server uses the configuration of the Federated Learning (FL) deployment to identify the data source that is used to train each of the machine learning models that have suffered a performance decay. The parameter server then determines whether machine learning models at other worker nodes that were trained using the identified data sources have also suffered a performance decay (e.g. by determining whether an indication of a potential drift has been received from the relevant worker nodes). Once it has been determined that all machine learning models trained using the identified data sources have also suffered a performance decay, an organic drift is confirmed as the type of drift.

If, in step 405 the parameter server determines that an organic drift has occurred, the enhanced aggregator updates the trusted data set in step 406 based on the data transmitted by the worker node. The updated trusted data set is subsequently communicated to the worker node 301 where training continues as normal. In an embodiment, the updated trusted dataset is communicated to all worker nodes in the Federated Learning (FL) system.

As well as identifying an organic drift, the parameter server is also configured to determine whether the potential drift is due to a concept drift. In contrast to an organic drift, a concept drift is detected by identifying a difference between the performance of two or more machine learning models at the worker node. Identifying a concept drift will now be discussed in relation to FIG. 5.

FIG. 5 shows a performance of two machine learning models at the same worker node according to an embodiment. FIG. 5 shows the performance of two models, particularly a local model 501 (i.e. a machine learning model trained on local data) and a shadow model 502 (i.e. a machine learning model trained with data received from other nodes).

The parameter server identifies a concept drift when a difference in performance between the two machine learning models (i.e. 501 and 502) exceeds a predetermined threshold. In an embodiment, the difference value is a magnitude (i.e. an absolute difference agnostic of sign). FIG. 5 shows two regions; an acceptable difference 503 and a non-acceptable difference 504. Once a difference between the machine learning models is greater than the predetermined threshold the performance enters the non-acceptable difference region 504. In order to identify a concept drift the parameter server determines whether performance of the two machine learning models consistently diverge.

In an embodiment, the performance of two models consistently diverge if the magnitude of the difference is greater than a predetermined threshold for a predetermined number of tests (i.e. a predetermined number of performance evaluations using the trusted data set).

In the case of FIG. 5 the performance of the local model 501 and the shadow model 502 consistently diverge. The parameter server subsequently identifies the affected machine learning model. Since the performance of the local model 501 is worse than the performance of the shadow model 502, the parameter server identifies the local model 501 as being the subject of concept drift.

FIG. 5 shows a comparison between two machine learning models. In this example a difference in the performance of each model can be used to indicate that a model has drifted. In a further embodiment anomaly detection is used to determine whether a drift has occurred when comparing more than two machine learning models. In a different embodiment a concept drift is detected when the performance of at least one model is below a performance threshold and the performance of at least one model is above the performance threshold.

Once the parameter server identifies a candidate machine learning model that is subject to concept drift, the parameter server (in particular the enhanced aggregator 406) determines a type of attack that resulted in the identified concept drift. The parameter server subsequently devises a rectification strategy for rectifying the concept drift at the infected worker nodes. Returning to FIG. 4, if in step 405 the parameter server determines that a concept drift has occurred at the worker node then the enhanced aggregator in the parameter server determines in step 406 the type of attack that could have caused the concept drift and therefore which other nodes in the deployment have been affected. As discussed above, there are various types of attack at the worker node that could result in a concept drift being observed, in order to identify the type of attack and therefore devise a rectification strategy, the parameter server observes the behaviour at other worker nodes in the Federated Learning (FL) deployment.

A first attack that could result in a concept drift being observed is when a node's data source is poisoned. An example of this type of attack is if the local data (e.g. D₁) of the first worker node 301 was corrupted. As can be seen in FIG. 3, the local data for each worker node is communicated to the data scheduler and to the local Federated Learning (FL) Scheduler 307.

In the case of a node-data attack, a performance decay (or drift) will be present in all of the worker nodes that use the infected data to train their machine learning models. Consequently, attacking the node data will affect the machine learning model trained using the local data source (e.g. the local machine learning model) as well as all of the shadow models on other worker nodes that receive data (via the data scheduler and their own local federated learning scheduler). In the case of the first worker node 301, an attack on the node data affects the local model of first worker node 301 and the shadow model of the second worker node 302 since this is the only worker node with which the data scheduler of the first worker node 301 communicates with.

In step 406 the parameter server identifies other machine learning models at other worker nodes in the Federated Learning (FL) deployment that are trained using the same data source as the affected machine learning model using its local knowledge of the Federated Learning (FL) deployment configuration. The parameter server subsequently monitors the status of machine learning models at other nodes that use the same training data source (e.g. by determining whether an indication that a potential drift has occurred at the applicable worker nodes). If the parameter server determines that all models trained using a single data source are the subject of concept drift then a node-data attack is detected. In response to identifying the affected worker nodes, the enhanced aggregator is configured to distribute rectification parameters to all worker nodes that use the infected data source to train a machine learning model.

The rectification parameters transmitted by the parameter server include an indication of a time when the affected machine learning model was stable. Upon receipt of the rectification parameters the worker node is configured to recover machine learning parameters of a global machine learning model the model history storage, from which it begin training the model again.

After identifying the machine learning models that are affected by a concept drift, the enhanced aggregator is configured to exclude machine learning models trained using the poisoned data source from the aggregation process.

A second type of attack that could result in a concept drift being observed is an attack on the local machine-learning model running on the worker node. This could take many forms including, but not limited to, an adversary changing the parameters of the machine learning model. In this case, the local data source is not poisoned therefore the concept drift will only be observed in the local machine learning model whose parameters have been changed. As a result, a concept drift will not be observed in the shadow models present at other worker nodes that are trained using the local data source.

A third type of attack that could result in a concept drift being observed is an attack on a local data surface of a worker node. In FIG. 3 a worker node is separated into a data plane and an AI plane. In FIG. 3 the data surface of the first worker node 301 is indicated by the boundary 311. In this respect, a data-surface attack corrupts the data communicated between the local data source and the local Federated Learning scheduler. However, the local data source itself is not poisoned. As a result, this type of attack does not affect the data communicated to other worker nodes for training shadow models.

In both the second and third types of attack discussed above, a performance decay will not be observed at worker nodes that train their shadow models using the local data source because to all external nodes the data source has not been poisoned. Instead, the drift is localised to the local machine learning model of the worker node in question.

After determining that a concept drift has occurred at a worker node, the parameter server is configured to determine whether the shadow models in the other worker nodes that use the same data source are also the subject of concept drift.

If it is determined that only one machine learning model has been the subject of concept drift (i.e. the local model of the worker node), then the parameter server identifies that an adversary has attacked the local machine learning model at the node in question (either through a data-surface attack or by changing the machine learning parameters). In common with the other attack types, after determining the affected worker nodes the parameter server is configured to generate and communicate rectification parameters. In this case, the parameter server only transmits rectification parameters to the worker node whose local model is attacked/infected.

Like with any other attack type, the affected machine learning models (i.e. the local models at the attacked node in the case of the second and third attack type) are excluded from the model aggregation process by the enhanced aggregator. However, shadow models of other nodes that receive data from the local data source of the attacked node are not excluded from aggregation by the enhanced aggregator because, as discussed above, they are not affected by the second or third types of attack.

A fourth type of attack that could result in a concept drift being observed is an “over-the-air” attack where the local data communicated externally (i.e. to the shadow models of other worker nodes) is compromised, however the data communicated to the local machine learning model is unaffected. In this case, a concept drift will be observed in all shadow models that are trained using this local data source, however the local model will be unaffected.

As discussed above, after determining that the potential drift reported by the worker node is a concept drift, the parameter server is configured to identify the other worker nodes in the Federated Learning (FL) deployment that comprise a machine learning model trained using the same data source as the affected machine learning model. The parameter server is subsequently configured to determine a concept drift is observable in one of: just the affected model, all machine learning models trained using the same data source, or just the shadow models associated with the data source. After determining which of these apply, the parameter server is configured to generate and implement a rectification strategy.

In the case of the fourth attack type, a concept drift will be observed in all shadow models that are trained with a data source, however the local model trained using that data source will be unaffected. In response to identifying that an “over-the-air” attack (i.e. an attack of the fourth type) has occurred, the enhanced aggregator is configured to exclude all shadow models trained using the compromised data from the aggregation process. The parameter server is further configured to transmit rectification parameters to the worker nodes comprising the affected shadow models.

FIG. 6 shows an example of drift in model performance, rectification of a model and recovered performance according to an embodiment. FIG. 6 shows the performance of a machine learning model 601 over time. At a first Epoch, eᵣ, the machine learning model has a level of performance that is within a predetermined tolerance 603. Consequently, no potential drift is identified and the parameters of the machine learning model are transmitted to parameter server where the parameters of an updated global machine learning model are generated. Parameters of the updated global model are subsequently transmitted to the worker node 301, where the worker node 301 stores the parameters in the model history storage.

At a second Epoch, e_{c1}, the performance of the machine learning model is less than or equal to the tolerance 603 and consequently the worker node begins the drift monitoring window 605. In the example shown in FIG. 6 the drift monitoring window lasts for the time between the second Epoch, e_{c1}, and a third Epoch, e_{c2}. At the time of the third Epoch, e_{c2}, the performance of the machine learning model is still below the acceptable tolerance 603. Consequently the worker node 301 identifies a potential drift has occurred. The worker node 301 subsequently transmits an indication that a potential drift has occurred to the parameter server as well as the local/shadow model parameters of the worker node, the assessment parameters of the models at the worker node, and the data that the machine learning models were trained with.

As discussed above, the parameter server subsequently determines the type of drift that is occurring. When a concept drift is detected the parameter server is configured to determine the affected worker nodes. Once the parameter server has identified the affected worker nodes, rectification parameters are transmitted by the parameter server to the affected worker nodes.

As discussed above, the rectification parameters comprise an indication of the last stable model point. In an embodiment, the indication is an index of the global machine learning model. The index representing a point in time when the affected machine learning model was associated with acceptable performance.

In response to receiving the rectification parameters the worker node 301 is configured to retrieve model parameters of the global machine learning model from the model history component, update the parameters of the affected machine learning model with the parameters of the retrieved model parameters, and begin training the previously affect model again.

In this way the Federated Learning (FL) system shown in FIG. 2 and FIG. 3 is able to characterise a type of drift and rectify it in order to maintain consistent performance over time.

FIG. 7 shows a visual representation of concept drift and rectification according to an embodiment. As discussed above, after receiving an indication that a potential drift has occurred from a worker node, the parameter server is configured to determine whether the performance of two machine learning models at the worker node consistently diverge. FIG. 7 shows the performance difference across k AI models present within the worker node, this performance difference over time is represented by a performance difference indicator 701.

Upon determining that the performance difference 701 between the machine learning models at the worker node exceeds a predetermined tolerance 702 for a predetermined time, the parameter server identifies that a concept drift 703 in a model has occurred.

Upon determining that a concept drift has occurred the parameter server is configured to determine the affected worker nodes. Once the affected nodes have been identified the parameter server is configured to transmit rectification parameters to the affected worker nodes comprising an indication (e.g. an index) of a time when the affected machine learning model had an acceptable performance (i.e. around point 706). After rectification is triggered at points 704 and 705 the performance of the machine learning model returns to an acceptable level 707. As discussed above, the number of worker nodes to which rectification parameters are communicated will depend on the type of attack identified by the parameter server.

FIG. 8A shows an example of a worker node according to an embodiment. The worker node 800 comprises a network interface 810, a processor 820 and a memory 830. The network interface 810 is configured to transmit and receive communications (via a wired or wireless connection). The processor 820 is configured to control the worker node 800 to perform the functions described herein. The memory 830 stores computer-readable instructions which, when executed by the processor 820, causes the processor 820 to enact the functionality described herein. Optionally, the worker node 800 comprises a sensor module 840 for generating raw data samples.

FIG. 8B shows an example of a parameter server according to an embodiment. FIG. 8B shows a parameter server 850 that comprises similar components as the worker node 800, as indicated by like reference numerals.

One use-case for the above described system and method is in the field of cyber security. An example of this relates to access-control of a distributed database that stores sensitive information.

A distributed database relates to a deployment where several database instances are deployed across a number of nodes. Distributed databases are generally more responsive to queries and, by virtue of being located across different nodes of the network, are generally more tolerant to sever downtime. In a distributed database scheme there is routinely one coordinator node that coordinates the data management at each local database.

In an embodiment, the distributed database scheme is deployed in the Federated Learning (FL) system discussed above. In this case, the parameters server is the coordinator node and a local database is stored on at least one of the worker nodes.

Each local database can be queried in order to retrieve data from the database. These transactions can originate from applications running on the node, or from applications running on other devices that are connected to the worker node. Each local database is responsible for fulfilling and authorising the received transactions/requests. This can be problematic since each worker node has a local database that is open to an attack via the querying mechanism. For example, when the database is an SQL database, each local database stored on the worker nodes is susceptible to an SQL injection attack, thereby potentially comprising the security of the sensitive information stored in the distributed database.

In an embodiment, the Federated Learning (FL) system discussed above is used to increase the cybersecurity of a distributed database system. In particular, the intelligent agents (e.g. machine learning models) running on each node are used to authorise database transactions based on at least one of: the nature of the requesting application, the end-user using the application and the data being retrieved. These variables are used as the input to the machine learning models and based on this information, the machine learning models are configured to output an indication of whether the transaction is authorised or not.

In an embodiment, the trusted data set comprises one or more pre-defined applications and/or one or more pre-authorised users. The characteristics associated with these applications and/or users are used by the machine-learning model to build trusted profiles. The local machine learning models are frequently retrained as the system evolves with new applications accessing the database, new data being stored in the database and new types of transactions being observed. The resulting machine learning models are communicated to the parameter server and aggregated into a global model as discussed above.

In an embodiment, the performance measure is determined by observing the machine learning model confidence.

Although the method is discussed in relation to a cyber-security use-case, other applications are also envisaged. For example, the above-described methods could be used in any Federated Learning (FL) system.

While certain arrangements have been described, the arrangements have been presented by way of example only, and are not intended to limit the scope of protection. The inventive concepts described herein may be implemented in a variety of other forms. In addition, various omissions, substitutions and changes to the specific implementations described herein may be made without departing from the scope of protection defined in the following claims.

1. A computer-implemented method for identifying and rectifying a machine learning drift in a federated learning deployment comprising a parameter server and a plurality of worker nodes, wherein a first worker node comprises:
a first machine learning model trained using a first data source; and
a second machine learning model trained using a second data source;
wherein the first data source is generated by the first worker node and the second data source is generated by a second worker node;
the method comprising:
calculating, by the first worker node, using a trusted data set, a first performance metric associated with the first machine learning model and a second performance metric associated with the second machine learning model;
determining, by the first worker node, whether a potential drift has occurred in at least one of the first and the second machine learning models; and
in response to determining that the potential drift has occurred:
transmitting, by the first worker node, a first communication comprising an indication that a potential drift has occurred; and
in response to receiving the first communication, transmitting, by the parameter server, a second communication comprising updated parameters for rectifying the machine learning drift.

2. The computer-implemented method according to claim 1 wherein determining whether the potential drift has occurred comprises:
comparing the first performance metric and the second performance metric to a first performance threshold; and
identifying the potential drift in response to determining that at least one of the first performance metric and the second performance metric has a performance metric that is less than the first performance threshold.

3. The computer-implemented method according to claim 2 wherein the second worker node comprises: a third machine learning model trained using the second data source; and a fourth machine learning model trained using the first data source.

4. The computer-implemented method according to claim 3 wherein the first communication comprises the first performance metric and the second performance metric and the method further comprises:
identifying, by the parameter server, a type of drift and a set of affected machine learning model in response to receiving the first communication comprising the indication that the potential drift has occurred.

5. The computer-implemented method according to claim 4 wherein the method further comprises:
receiving, by the parameter server, a third performance metric associated with the third machine learning model and a fourth performance metric associated with the fourth machine learning model; and wherein:
identifying the type of drift comprises:
setting organic drift as the type of drift in response to determining that the first performance metric, the second performance metric, the third performance metric and the fourth performance metric are each less than a second performance threshold; and wherein, in response to determining that the type of drift is organic drift identifying the set of affected machine learning models comprises:
setting the first, second, third and fourth machine learning models as a first, second, third, and fourth affected machine learning model respectively in the set of affected machine learning models.

6. The computer-implemented method according to claim 5 wherein the updated parameters in the second communication transmitted by the parameter server comprise an updated trusted data set.

7. The computer-implemented method according to claim 4 wherein:
identifying the type of drift comprises:
setting a concept drift as the type of drift in response to determining that a difference between the first performance metric and the second performance metric exceeds a third threshold; and wherein, in response to determining that the type of drift is a concept drift, identifying the set of affected machine learning models comprises:
setting the first machine learning model as a first affected machine learning model in the set of affected machine learning models in response to determining that the first performance metric is less than the second performance metric; and
setting the second machine learning model as the first affected machine learning model in the set of affected machine learning models in response to determining that the second performance metric is less than the first performance metric.

8. The computer-implemented method according to claim 7 wherein the type of drift is a concept drift and identifying the set of affected machine learning model further comprises:
identifying a data source that is used to train the first affected machine learning model;
identifying a worker node comprising a machine learning model trained using the data source; and
setting the machine learning model trained using the data source as a second affected machine learning model in response to determining that a concept drift has occurred at the worker node and the machine learning model training using the data source has a lower performance metric than a performance metric of another machine learning model at the worker node.

9. The computer-implemented method according to claim 8 wherein the second communication comprising the updated parameters is transmitted to each worker node comprising an affected machine learning model in the set of affected machine learning models.

10. The computer-implemented method according to claim 4 further comprising:
transmitting, by the first worker node, model parameters of the first machine learning model and the second machine learning model;
generating, by the parameter server, a first global machine learning model associated with the first machine learning model and a second global machine learning model associated with the second machine learning model; and
transmitting, by the parameter server, a third communication comprising: model parameters of the first global machine learning model and model parameters of the second global machine learning model.

11. The computer-implemented method according to claim 10 wherein generating the first global machine learning model comprises:
identifying a first set of machine learning models for aggregation, the first set of machine learning models not including the set of affected machine learning models; and
aggregating the first set of machine learning models.

12. The computer-implemented method according to claim 10 wherein the updated parameters of the second communication comprise:
an indication that a machine learning model trained using the first data source has been affect by concept drift; and
an indication of a time when the first global machine learning model was associated with acceptable performance.

13. The computer-implemented method according to claim 12 further comprising:
receiving, by the first worker node, the second communication;
identifying, by the first worker node, model parameters of the first global machine learning model that are associated with the indication of the time in the second communication; and
re-configuring, by the first worker node, the first machine learning model based on the model parameters of the first global machine learning model.

14. A computer-implemented method for identifying and rectifying a machine learning drift at a first worker node, the first worker node comprising:
a first machine learning model trained using a first data source; and
a second machine learning model trained using a second data source;
wherein the first data source is generated by the first worker node and the second data source is generated by a second worker node;
the method comprising:
calculating, using a trusted data set, a first performance metric associated with the first machine learning model and a second performance metric associated with the second machine learning model;
determining, whether a potential drift has occurred in at least one of the first and the second machine learning models; and
in response to determining that the potential drift has occurred:
transmitting, a first communication comprising an indication that a potential drift has occurred; and
receiving, a second communication comprising updated parameters for rectifying the machine learning drift.

15. The computer-implemented method according to claim 14 wherein determining whether the potential drift has occurred comprises:
comparing the first performance metric and the second performance metric to a first performance threshold; and
identifying the potential drift in response to determining that at least one of the first performance metric and the second performance metric has a performance metric that is less than the first performance threshold.

16. The computer-implemented method according to claim 15 further comprising:
receiving a third communication comprising:
model parameters of the first global machine learning model; and
model parameters of the second global machine learning model; and
storing the model parameters of the first global machine learning model and the model parameters of the second global machine learning model.

17. The computer-implemented method according to claim 16 wherein the model parameters of the first global machine learning model and the model parameters of the second global machine learning model are removed after a predetermined period of time has elapsed.

18. The computer-implemented method according to claim 17 wherein the updated parameters of the second communication comprise:
an indication that a machine learning model trained using the first data source has been affect by concept drift; and
an indication of a time when the first global machine learning model was associated with acceptable performance.

19. The computer-implemented method according to claim 18 further comprising:
receiving the second communication;
identifying model parameters of the first global machine learning model that are associated with the indication of the time in the second communication; and
re-configuring the first machine learning model based on the model parameters of the first global machine learning model.

20. A computer-implemented method for identifying and rectifying a machine learning drift in a federated learning deployment comprising a plurality of worker nodes, wherein a first worker node comprises:
a first machine learning model trained using a first data source; and
a second machine learning model trained using a second data source;
wherein the first data source is generated by the first worker node and the second data source is generated by a second worker node;
the method comprising:
receiving, from a first worker node, a first communication comprising an indication that a potential drift has occurred; and
transmitting a second communication comprising updated parameters for rectifying the machine learning drift.
